(19) United States
(12) Patent Application Publication
(10) Pub. No.: US 2015/0010748 A1
(43) Pub. Date: Jan. 8, 2015

(54) BASIC COMPOSITIONS INCLUDING INORGANIC OXIDE NANOPARTICLES AND AN ORGANIC BASE, COATED SUBSTRATES, ARTICLES AND METHODS

(71) Applicants: Xue-Hua Chen, Shanghai (CN); Yu Yang, Eden Prairie, MN (US); Dong-Wei Zhu, Shoreview, MN (US); Ping Zhou, Shanghai (CN); Bin Yu, Shanghai (CN)

(72) Inventors: Xue-Hua Chen, Shanghai (CN); Yu Yang, Eden Prairie, MN (US); Dong-Wei Zhu, Shoreview, MN (US); Ping Zhou, Shanghai (CN); Bin Yu, Shanghai (CN)

(21) Appl. No.: 14/371,263

(22) PCT Filed: Feb. 27, 2012
(86) PCT No.: PCT/CN2012/071667

§ 371 Date: Jul. 9, 2014

(51) Int. Cl. C09D 7/12; B05D 1/40; B05D 1/28; B05D 3/04; B05D 3/10

(52) U.S. Cl. CPC C09D 7/1216; B05D 3/0413; B05D 3/101; B05D 1/28; B05D 1/40; C09D 7/1233
USPC 428/329; 428/323; 427/372.2; 427/301; 427/397.7

(57) ABSTRACT

Basic coating compositions including inorganic oxide nanoparticles and an organic base are described. Methods of coating a substrate with the coating compositions, coated substrates prepared using the methods, and articles that include the coated substrates are also disclosed.

### BACKGROUND

Substrates having surfaces that include inorganic oxide nanoparticle coatings (i.e., films) can be used in a wide variety of applications. Such oxide coatings are typically continuous coatings and can help protect organic polymer substrates because such coatings are normally harder than organic polymers such as polyesters and polycarbonates. Such coatings can also impart surfaces with lower or higher surface energy than their substrates and therefore provide desired surface properties. For example, such coatings can be capable of spreading water (when the surface energy is high), and thus preventing the formation of water droplets on the surface of an article such as transparent plastics used in misty or humid environments, glass windows of greenhouses, or traffic signs that employ retroreflective sheeting. On the other hand, when the surface energy is low, water and other liquids will not wet the surface, and thus, it possesses anti-graffiti and/or easy-clean properties.

### SUMMARY

The present disclosure is directed to basic film forming coating compositions including inorganic oxide nanoparticles and an organic base, as well as methods and coated substrates. Preferably, these formulations are aqueous compositions. Preferably, they do not include organic polymer binders or film formers. The exclusion of these organic materials (binders and film formers) preferably makes the coatings (i.e., films) formed from the coating compositions of the present disclosure durable under severe outdoor weathering conditions.

In one embodiment, the present disclosure provides a coating composition (preferably, an aqueous coating composition) that includes inorganic oxide nanoparticles having an average primary particle size of 40 nanometers or less and an organic base. Certain embodiments also include a surfactant. Certain embodiments also include water. The coating composition is preferably an aqueous dispersion having a pH of greater than 8.

In another embodiment, the present disclosure provides an aqueous coating composition that includes: 0.5 to 99 wt-% water, based on the total weight of the composition; 0.1 to 20 wt-% inorganic oxide nanoparticles having an average primary particle size of 40 nm or less, based on the total weight of the composition; 0.1 wt-% to 20 wt-% of an organic base, based on the total weight of the dry inorganic oxide nanoparticles; and 0 to 10 wt-% of a surfactant, based on the dry weight of inorganic oxide nanoparticles. The coating composition preferably has a pH of greater than 8.

In yet another embodiment, the present disclosure provides an aqueous coating composition that includes: 0.5 to 99 wt-% water, based on the total weight of the composition; 0.1 to 20 wt-% inorganic oxide nanoparticles having an average primary particle size of 40 nm or less, based on the total weight of the composition; 0 to 20 wt-% inorganic oxide nanoparticles having an average primary particle size of 40 nm or more; wherein the total amount of inorganic oxide nanoparticles is 0.1 to 40 wt-%, based on the total weight of the coating composition; 0.1 wt-% to 20 wt-% of an organic base, based on the total weight of the dry inorganic oxide nanoparticles; and 0.1 wt-% to 10 wt-% of a surfactant, based on the dry weight of inorganic oxide nanoparticles. The coating composition preferably has a pH of greater than 8.

The present disclosure also provides methods of coating. In one embodiment, a method of coating a substrate is provided, wherein the method includes: contacting a surface of a substrate with a coating composition that includes: inorganic oxide nanoparticles having an average primary particle size of 40 nanometers or less; and an organic base. The method further includes drying the coating composition on the substrate to provide a condensed inorganic oxide nanoparticle coating.

As mentioned above, the coating composition can further include water. For such compositions, preferably the coating composition is an aqueous dispersion having a pH of greater than 8. For methods of coating aqueous compositions, a method preferably includes: contacting a surface of a substrate with an aqueous coating composition as described herein, wherein a surfactant is present in the aqueous coating composition, disposed on the substrate surface prior to contact with the aqueous coating composition, or both in the aqueous coating composition and disposed on the substrate surface prior to contact with the aqueous coating composition; and drying the aqueous coating composition on the substrate to provide a condensed inorganic oxide nanoparticle coating.

The present disclosure further provides a coated substrate, and an article comprising a substrate, particularly a polymeric substrate, having an inorganic oxide nanoparticle coating thereon. The coating comprises a continuous coating of condensed (i.e., agglomerated) inorganic oxide nanoparticles which have an average primary particle size of 40 nanometers or less. The coating is substantially uniform in thickness and is durably adhered to the substrate.

The terms “comprises” and variations thereof do not have a limiting meaning where these terms appear in the description and claims.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

As used herein, “a,” “an,” “the,” “at least one,” and “one or more” are used interchangeably. Thus, for example, an aqueous coating composition that comprises “a” base can be interpreted to mean that the aqueous coating composition includes “one or more” bases. Similarly, an aqueous coating composition that comprises “a” surfactant can be interpreted to mean that the aqueous coating composition includes “one or more” surfactants.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the terms “room temperature” or “ambient temperature” refers to a temperature of 20° C. to 25° C. or 22° C. to 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a comparison of Percent Transmittance between Comparative Example K and Example 1 over a range of wavelengths.

### DETAILED DESCRIPTION OF ILLUSTRATIVE EMBODIMENTS

The present disclosure provides a coating composition that includes: inorganic oxide nanoparticles having an average primary particle size of 40 nanometers or less and an organic base. Certain embodiments also include a surfactant. Certain embodiments of a coating composition of the present disclosure include water. Certain embodiments of a coating composition of the present disclosure are aqueous dispersion having a pH of greater than 8, or greater than 8.5, or greater than 9. Such coating compositions can be used in methods to create coated (preferably, continuously coated) substrates useful in a variety of articles for a variety of applications.

Coating compositions of the present disclosure can include water, an organic solvent, or combinations thereof. The organic solvent is usually selected to be miscible with water. Typical organic solvents include alcohols. In certain embodiments, the coating composition is an aqueous composition, preferably an aqueous dispersion. In this context, an “aqueous” composition or “aqueous” dispersion is one that includes water and optionally one or more organic solvents (e.g., an alcohol). Such organic solvent(s), if present in a coating composition, can be present in a wide range of amounts. For certain embodiments, an aqueous composition has no greater than 10 wt-% organic solvent, based on the weight of the water/organic solvent mixture. For such embodiments, preferably, there is no greater than 5 wt-% organic solvent, more preferably no greater than 2 wt-% organic solvent, even more preferably no greater than 1 wt-% organic solvent, based on the weight of the water/organic solvent mixture.

The base used in the coating compositions of the present disclosure is an organic base. The surfactant used in the coating compositions of the present disclosure can be nonionic, anionic, zwitterionic, or a combination thereof.

### Organic Bases

The base used in the coating compositions of the present disclosure is an organic base. A sufficient amount of organic base is used to form a condensed inorganic oxide nanoparticle coating upon applying and drying a coating composition on a substrate.

In certain embodiments, this amount is preferably at least 0.1 wt-%, more preferably at least 1 wt-%, and even more preferably at least 2 wt-%, based on the total weight of dry inorganic oxide nanoparticles. In certain embodiments, this amount is preferably no greater than 20 wt-%, more preferably no greater than 10 wt-%, and even more preferably no greater than 5 wt-%, based on the total weight of dry inorganic oxide nanoparticles.

In certain embodiments, aqueous coating compositions of the present disclosure include sufficient organic base to provide a pH of greater than 8, preferably greater than 8.5, and more preferably greater than 9. Significantly, an organic base does not raise the pH as significantly as an inorganic base, yet, surprisingly, provides sufficient crosslinking and/or curing of the coating composition. Also, typically, very little organic base is needed to provide such pH and effective crosslinking.

The coating (preferably, continuous coating) is formed by the condensation of the inorganic oxide nanoparticles. This condensation reaction is known to be initiated by acids, especially strong acids. However, the corrosive effect of strong acids limits its practice in industrial coating lines. When a mild acid is used, the final coating performances are compromised. Alternatively, if acid is not desired, continuous coatings can only be formed under high temperatures (for examples, great than 150° C.). An organic base overcomes the shortcomings of using acid or high temperatures. The use of an organic base allows for greater flexibility in manufacturing since they are not corrosive in industrial coating lines like strong acids.

Desirably, an organic base has sufficiently strong activity such that coating compositions can be cured at low temperatures (e.g., as low as ambient temperature) and/or fast speeds (e.g., on the order of minutes). Low temperature cure not only improves coating speeds but also reduces the stress on organic polymer substrates (many of which cannot be easily handled at temperatures above 120° C.). Ambient curing allows for the application of coating compositions without an extra heating step.

Although not intending to be necessarily limiting, it is believed that the organic base functions as a catalyst. The inorganic oxide nanoparticles have surface hydroxy groups, which condense to form a coating, preferably, a continuous coating. This condensation reaction can happen without the presence of base, but only at elevated temperatures. With the presence of a catalytic amount of an organic base, the condensation reaction becomes much faster and it can occur at ambient temperatures.

An organic base, as disclosed herein, when compared to known acids, provides one or more of the following advantages: little or no corrosion to coating equipment; high efficiency due to the presence of a small amount of organic base (e.g., as low as 1% by weight of silica); stable water-based formulations (e.g., a coating composition of the present disclosure is stable with no pot life issues and without the need of adding any coalescent solvents); good adhesion to substrates (e.g., coatings produced are of good adhesion to a wide variety of substrates including organic and inorganic materials such as polyethylene terephthalate (PET), polycarbonate, ceramic, glass, and metals); and more durable coatings on polycarbonate.

Suitable organic bases for use in the compositions of the present disclosure include, but are not limited to, amidines, guanidines (including substituted guanidines such as biguanides), phosphazenes, proazaphosphatranes (also known as Verkade's bases), alkyl ammonium hydroxide, and combinations thereof. Self-protonatable forms of the bases (for example, aminoacids such as arginine) generally are less suitable and therefore excluded, as such forms tend to be at least partially self-neutralized. Preferred bases include amidines, guanidines, and combinations thereof (more preferably, amidines and combinations thereof; most preferably, cyclic amidines and combinations thereof).

The organic bases can be used in the curable composition singly (individually) or in the form of mixtures of one or more different bases (including bases from different structural classes). If desired, the base(s) can be present in photolatent form (for example, in the form of an activatable composition that, upon exposure to radiation or heat, generates the base(s) in situ).

Useful amidines include those that can be represented by the following general formula:

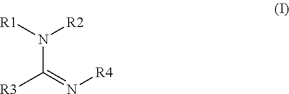

wherein R1, R2, R3, and R4 are each independently selected from hydrogen, monovalent organic groups, monovalent heteroorganic groups (for example, comprising nitrogen, oxygen, phosphorus, or sulfur in the form of groups or moieties that are bonded through a carbon atom and that do not contain acid functionality such as carboxylic or sulfonic), and combinations thereof; and wherein any two or more of R1, R2, R3, and R4 optionally can be bonded together to form a ring structure (preferably, a five-, six-, or seven-membered ring; more preferably, a six- or seven-membered ring. The organic and heteroorganic groups preferably have from 1 to 20 carbon atoms (more preferably, from 1 to 10 carbon atoms; most preferably, from 1 to 6 carbon atoms).

Amidines comprising at least one ring structure (that is, cyclic amidines) are generally preferred. Cyclic amidines comprising two ring structures (that is, bicyclic amidines) are more preferred.

Representative examples of useful amidine compounds include 1,2-dimethyl-1,4,5,6-tetrahydropyrimidine, 1-ethyl-2-methyl-1,4,5,6-tetrahydropyrimidine, 1,2-diethyl-1,4,5,6-tetrahydropyrimidine, 1-n-propyl-2-methyl-1,4,5,6-tetrahydropyrimidine, 1-isopropyl-2-methyl-1,4,5,6-tetrahydropyrimidine, 1-ethyl-2-n-propyl-1,4,5,6-tetrahydropyrimidine, 1-ethyl-2-isopropyl-1,4,5,6-tetrahydropyrimidine, DBU (that is, 1,8-diazabicyclo[5.4.0]-7-undecene), DBN (that is, 1,5-diazabicyclo[4.3.0]-5-nonene), and the like, and combinations thereof. Preferred amidines include 1,2-dimethyl-1,4,5,6-tetrahydropyrimidine, DBU (that is, 1,8-diazabicyclo[5.4.0]-7-undecene), DBN (that is, 1,5-diazabicyclo[4.3.0]-5-nonene), and combinations thereof, with DBU, DBN, and combinations thereof being more preferred and with DBU being most preferred.

Useful guanidines include those that can be represented by the following general formula:

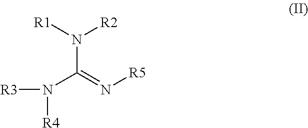

wherein R1, R2, R3, R4, and R5 are each independently selected from hydrogen, monovalent organic groups, monovalent heteroorganic groups (for example, comprising nitrogen, oxygen, phosphorus, or sulfur in the form of groups or moieties that are bonded through a carbon atom and that do not contain acid functionality such as carboxylic or sulfonic), and combinations thereof; and wherein any two or more of R1, R2, R3, R4, and R5 optionally can be bonded together to form a ring structure (preferably, a five-, six-, or seven-membered ring; more preferably, a five- or six-membered ring; most preferably, a six-membered ring. The organic and heteroorganic groups preferably have from 1 to 20 carbon atoms (more preferably, from 1 to 10 carbon atoms; most preferably, from 1 to 6 carbon atoms).

Guanidines comprising at least one ring structure (that is, cyclic guanidines) are generally preferred. Cyclic guanidines comprising two ring structures (that is, bicyclic guanidines) are more preferred.

Representative examples of useful guanidine compounds include 1-methylguanidine, 1-n-butylguanidine, 1,1-dimethylguanidine, 1,1-diethylguanidine, 1,1,2-trimethylguanidine, 1,2,3-trimethylguanidine, 1,3-diphenylguanidine, 1,1,2,3,3-pentamethylguanidine, 2-ethyl-1,1,3,3-tetramethylguanidine, 1,1,3,3-tetramethyl-2-n-propylguanidine, 1,1,3,3-tetramethyl-2-isopropylguanidine, 2-n-butyl-1,1,3,3-tetramethylguanidine, 2-tert-butyl-1,1,3,3-tetramethylguanidine, 1,2,3-tricyclohexylguanidine, TBD (that is, 1,5,7-triazabicyclo[4.4.0]dec-5-ene), MTBD (that is, 7-methyl-1,5,7-triazabicyclo[4.4.0]dec-5-ene), 7-ethyl-1,5,7-triazabicyclo[4.4.0]dec-5-ene, 7-n-propyl-1,5,7-triazabicyclo[4.4.0]dec-5-ene, 7-isopropyl-1,5,7-triazabicyclo[4.4.0]dec-5-ene, 7-n-butyl-1,5,7-triazabicyclo[4.4.0]dec-5-ene, 7-isobutyl-1,5,7-triazabicyclo[4.4.0]dec-5-ene, 7-tert-butyl-1,5,7-triazabicyclo[4.4.0]dec-5-ene, 7-cyclohexyl-1,5,7-triazabicyclo[4.4.0]dec-5-ene, 7-n-octyl-1,5,7-triazabicyclo[4.4.0]dec-5-ene, 7-2-ethylhexyl-1,5,7-triazabicyclo[4.4.0]dec-5-ene, 7-decyl-1,5,7-triazabicyclo[4.4.0]dec-5-ene, biguanide, 1-methylbiguanide, 1-n-butylbiguanide, 1-(2-ethylhexyl)biguanide, 1-n-octadecylbiguanide, 1,1-dimethylbiguanide, 1,1-diethylbiguanide, 1-cyclohexylbiguanide, 1-allylbiguanide, 1-n-butyl-N2-ethylbiguanide, 1,1′-ethylenebisguanide, 1-[3-(diethylamino)propyl]biguanide, 1-[3-(dibutylamino)propyl]biguanide, N′,N″-dihexyl-3,12-diimino-2,4,11,13-tetraazatetradecanediamidine, and the like, and combinations thereof. Preferred guanidines include TBD (that is, 1,5,7-triazabicyclo[4.4.0]dec-5-ene), MTBD (that is, 7-methyl-1,5,7-triazabicyclo[4.4.0]dec-5-ene), 2-tert-butyl-1,1,3,3-tetramethylguanidine, and combinations thereof. More preferred are TBD, MTBD, and combinations thereof.

If desired, the amidines and guanidines can be selected from those exhibiting a pH value lower than 13.4 when measured according to JIS Z 8802 (for example, 1,3-diphenylguanidine, DBU, DBN, or a combination thereof; preferably, DBU, DBN, or a combination thereof). The referenced method for determining the pH of aqueous solutions, JIS Z 8802, is carried out by first preparing an aqueous solution of base by adding 5 millimole of base to 100 g of a mixed solvent composed of isopropyl alcohol and water in a weight ratio of 10:3. The pH of the resulting solution is then measured at 23° C. using a pH meter (for example, a Horiba Seisalcusho Model F-22 pH meter).

Useful phosphazenes include those that can be represented by the following general formula:

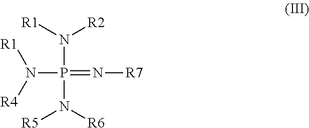

wherein R1, R2, R3, R4, R5, R6, and R7 are each independently selected from hydrogen, monovalent organic groups, monovalent heteroorganic groups (for example, comprising nitrogen, oxygen, phosphorus, or sulfur in the form of groups or moieties that are bonded through a carbon atom and that do not contain acid functionality such as carboxylic or sulfonic), and combinations thereof; and wherein any two or more of R1, R2, R3, R4, R5, R6, and R7 optionally can be bonded together to form a ring structure (preferably, a five-, six-, or seven-membered ring; more preferably, a five- or six-membered ring; most preferably, a six-membered ring. The organic and heteroorganic groups preferably have from 1 to 20 carbon atoms (more preferably, from 1 to 10 carbon atoms; most preferably, from 1 to 6 carbon atoms

Representative examples of useful phosphazene compounds include:

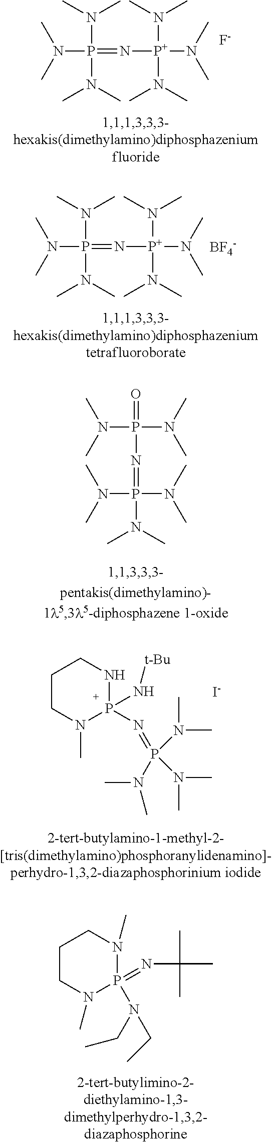

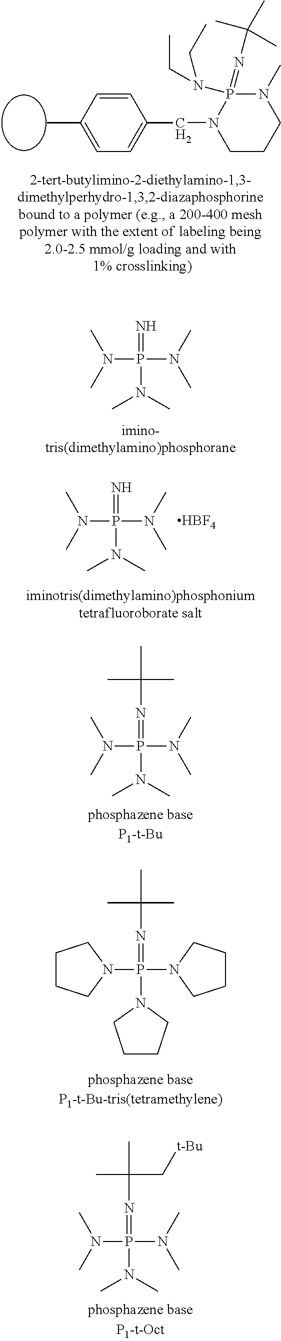

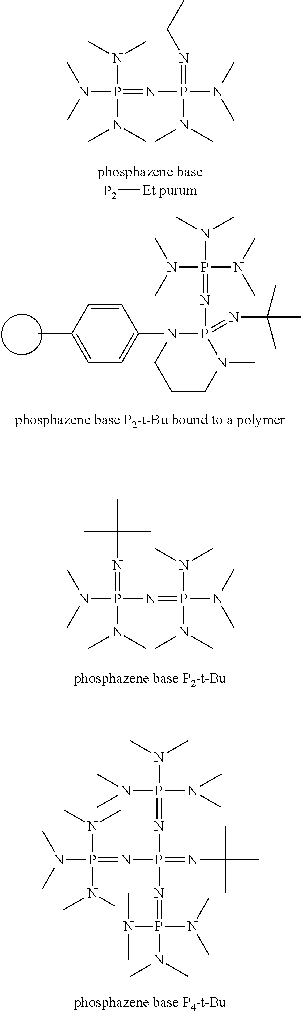

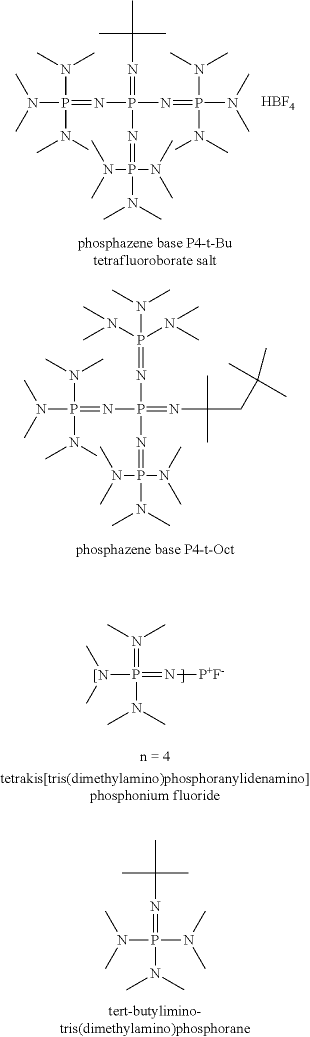

and the like, and combinations thereof. Preferred phosphazenes include 2-tert-butylimino-2-diethylamino-1,3-dimethylperhydro-1,3,2-diazaphosphorine, phosphazene base P₁t-Bu-tris(tetramethylene), phosphazene base P₄-t-Bu, and combinations thereof. A circle in the above chemical structures represents a polymeric material. That is, the organic base can be a group attached to a polymeric material.

Useful proazaphosphatrane bases (Verkade's bases) include those that can be represented by the following general formula:

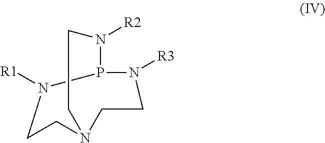

wherein R1, R2, and R3 are each independently selected from hydrogen, monovalent organic groups, monovalent heteroorganic groups (for example, comprising nitrogen, oxygen, phosphorus, or sulfur in the form of groups or moieties that are bonded through a carbon atom and that do not contain acid functionality such as carboxylic or sulfonic), and combinations thereof; and wherein any two or more of R1, R2, and R3 optionally can be bonded together to form a ring structure. The organic and heteroorganic groups preferably have from 1 to 20 carbon atoms (more preferably, from 1 to 10 carbon atoms; most preferably, from 1 to 6 carbon atoms).

Representative examples of useful proazaphosphatrane compounds include:

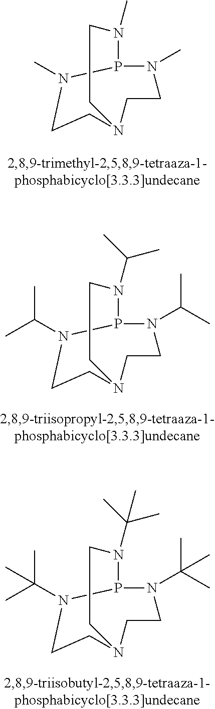

and the like, and combinations thereof. 2,8,9-Triisopropyl-2,5,8,9-tetraaza-1-phosphabicyclo[3.3.3]undecane is a particularly preferred proazaphosphatrane compound.

As specific examples of the alkyl ammonium compound, there may be mentioned tetramethyl ammonium hydroxide (TMAH), tetra-ethyl ammonium hydroxide (TEAH), tetrapropyl ammonium hydroxide (TPAH), tetrabutyl ammonium hydroxide (TBAH), tributylmethyl ammonium hydroxide (TBMAH), and so on.

### Surfactants

In some embodiments, coating compositions of the present disclosure can include one or more surfactants. For water-based formulations, the presence of one or more surfactants is needed in a majority of cases to help reduce the surface tension and wet organic polymer substrates. Alternatively or additionally, a surfactant can be coated on a substrate on which the coating composition is to be applied. Useful surfactants include a nonionic surfactant, an anionic surfactant, or a zwitterionic surfactant, that are capable of reducing the surface tension of the coating composition and improve the uniformity of the resulting coatings.

For typical concentrations of inorganic oxide nanoparticles (e.g., 0.2 to 15 percent by weight 15, relative to the total coating composition) most surfactants are preferably present in an amount of no greater than 10 percent by weight (wt-%), more preferably no greater than 5 wt-%, and even more preferably no greater than 1 wt-%, based on the dry weight of inorganic oxide nanoparticles. Preferably, at least 0.1 wt-%, surfactant is present in a coating composition of the present disclosure, based on the dry weight of inorganic oxide nanoparticles.

Useful nonionic surfactants include, but are not limited to, wetting agents such as polyethoxylated alkyl alcohols (e.g., BRIJ 30, and BRIJ 35, commercially available from ICI Americas, Inc., and TERGITOL TMN-6 Specialty Surfactant, commercially available from Dow Chemical), polyethoxylated alkylphenols (e.g., TRITON X-100 from Dow Chemical, ICONOL NP-70 from BASF Corp.), and polyethylene glycol/polypropylene glycol block copolymer (commercially available as TETRONIC 1502 Block Copolymer Surfactant, TETRONIC 908 Block Copolymer Surfactant and PLURONIC F38 Block Copolymer Surfactant, all from BASF, Corp.). Other commercially available nonionic surfactants include those available under the trade designations SURFYNOL 465 (ethoxylated 2,4,7,9-tetramethyl-5-decyne-4,7-diol containing 10 units of ethylene oxide per molecule), SURFYNOL 485 W(ethoxylated 2,4,7,9-tetramethyl 5 decyn-4,7-diol in water), and SURFYNOL 504 (greater than 25 wt-% ethoxylated 2,4,7,9-tetramethyl 5 decyn-4,7-diol in water and greater than 25 wt-% butanedioic acid, sulfo-, 1,4-Bis(2-ethylhexyl) ester, sodium salt) from Air Products & Chemicals.

Useful anionic surfactants include, but are not limited to, those with molecular structures including (1) at least one hydrophobic moiety, such as a C₆-C₂₀-alkyl, -alkylaryl, and/or -alkenyl group, (2) at least one anionic group, such as sulfate, sulfonate, phosphate, polyoxyethylene sulfate, polyoxyethylene sulfonate, polyoxyethylene phosphate, and the like, and/or (3) the salts of such anionic groups, wherein said salts include alkali metal salts, ammonium salts, tertiary amino salts, and the like. Representative commercial examples of useful anionic surfactants include sodium lauryl sulfate, available under the trade name TEXAPON L-100 from Henkel Inc., Wilmington, Del., or under the trade name POLYSTEP B-3 from Stepan Chemical Co, Northfield, Ill.; sodium lauryl ether sulfate, available under the trade name POLYSTEP B-12 from Stepan Chemical Co., Northfield, Ill.; ammonium lauryl sulfate, available under the trade name STANDAPOL A from Henkel Inc., Wilmington, Del.; and sodium dodecyl benzene sulfonate, available under the trade name SIPONATE DS-10 from Rhone-Poulenc, Inc., Cranberry, N.J.

Useful zwitterionic surfactants include, but are not limited to, betaine like Genagen KB (30 wt-% aqueous solution of alkyldimethyl betaine) and Genegen CAB (coco amido propyl betaine) from Clariant Corporation; and N-coco-aminopropionic acid like MIRATAINE AP-C from Rhone-Poulenc.

### Inorganic Oxide Nanoparticles

The inorganic oxide nanoparticles used in this composition are submicron size inorganic oxide nanoparticles, which may be metal oxide or non-metal oxide nanoparticles. Suitable inorganic oxide nanoparticles have an average primary particle size of 40 nanometers (nm) or less. In certain embodiments, the inorganic oxide nanoparticles have an average primary particle size of 20 nm or less. In certain embodiments, the inorganic oxide nanoparticles have an average primary particle size of 10 nm or less. The average primary particle size may be determined using transmission electron microscopy. Herein, the particle size is the longest dimension of a particle, which is the diameter for a spherical particle.

The particles preferably have narrow particle size distributions, that is, a polydispersity of 2.0 or less, preferably 1.5 or less. Further, the nanoparticles generally have a surface area greater than 150 square meters per gram (m²/g), preferably greater than 200 m²/g, and more preferably greater than 400 m²/g.

In certain embodiments, the concentration of the inorganic oxide nanoparticles having an average primary particle size (preferably, diameter) of 40 nm or less is at least 0.1 wt-%, and preferably at least 0.2 wt-%, based on the total weight of the coating composition. In certain embodiments, the concentration of the inorganic oxide nanoparticles having an average primary particle size (preferably, diameter) of 40 nm or less is no greater than 20 wt-%, and preferably no greater than 15 wt-%, based on the total weight of the coating composition.

If desired, larger inorganic oxide nanoparticles may be added, in amounts that do not reduce the transmissivity values and/or antifog properties. These additional inorganic oxide nanoparticles generally have an average primary particle size (longest dimension) of greater than 40 nm, and preferably greater than 50 nm. These additional inorganic oxide nanoparticles generally have an average primary particle size of no greater than 100 nm. These larger particles may be used in a ratio of 0.2:99.8 to 99.8:0.2, relative to the weight of the inorganic oxide nanoparticles of 40 nm or less. If used, these larger particles are preferably present in a ratio of 1:9 to 9:1, relative to the weight of the inorganic oxide nanoparticles of 40 nm or less.

In certain embodiments, the total weight of inorganic oxide nanoparticles (i.e., the total amount of nanoparticles of 40 nm or less and the larger inorganic oxide nanoparticles) in the composition is at least 0.1 wt-%, preferably at least 1 wt-%, and more preferably at least 2 wt-%. In certain embodiments, the total weight of inorganic oxide nanoparticles in the composition is no greater than 40 wt-%, preferably no greater than 10 wt-%, and more preferably no greater than 7 wt-%.

The inorganic oxide nanoparticles can include non-metal oxide nanoparticles, preferably silica nanoparticles. Inorganic silica sols in aqueous media are well known in the art and available commercially. Non-aqueous silica sols (also called silica organosols) may also be used and are silica sol dispersions wherein the liquid phase is an organic solvent, or an aqueous mixture containing an organic solvent. In the practice of this disclosure, the silica sol is chosen so that its liquid phase is compatible with the dispersion, and is typically an aqueous solvent, optionally including an organic solvent. The inorganic oxide nanoparticles do not typically include fumed silica.

Silica sols in water or water-alcohol solutions are available commercially under such trade names as LUDOX (manufactured by E.I. duPont de Nemours and Co., Inc., Wilmington, Del.), NYACOL (available from Nyacol Co., Ashland, Mass.), or NALCO (manufactured by Ondea Nalco Chemical Co., Oak Brook, Ill.). One useful silica sol is NALCO 2326 available as a silica sol with mean particle size of 5 nanometers, pH 10.5, and solid content 15% by weight. Other commercially available silica nanoparticles include those available under the trade designations NALCO 1115 (spherical, 4 nm, 15 wt-% dispersion), NALCO 1130 (spherical, 8 nm, 30 wt-% dispersion), NALCO 1050 (spherical, 20 nm, 50 wt-% dispersion), NALCO 2327 (spherical, 20 nm, 40 wt-% dispersion), NALCO 8699 (spherical, 2 nm, 15 wt-% dispersion), NALCO 1030 (spherical, 13 nm, 30 wt-% dispersion), NALCO 1060 (spherical, 60 nm, 50 wt-% dispersion), NALCO 2329 (spherical, 75 nm, 40 wt-% dispersion), and DVSZN004 (spherical, 45 nm, 42 wt-% dispersion) available from Nalco Chemical Co. Other commercially available silica nanoparticles include those silica nanoparticle dispersions available under the trade designations ST-OUP (elongated, 40-100 nm, 15 wt-%, pH=2-4), ST-UP (elongated, 40-100 nm, 20 wt-%, pH=9.0-10.5), ST-ZL (spherical, 70-100 nm, 40-41 wt-%), and ST-PS-S (100 nm, 19.2 wt-%) available from Nissan Chemical Industry, as well as REMASOL SP30, commercially available from Remet Corp., and LUDOX SM, commercially available from E.I. duPont de Nemours Co., Inc. The particle sizes are the mean particle size of the longest dimension.

The inorganic oxide nanoparticles can include metal oxide nanoparticles, including, for example aluminum oxide, titanium oxide, tin oxide, antimony oxide, antimony-doped tin oxide, indium oxide, tin-doped indium oxide, zinc oxide, etc. Preferably, the metal oxide nanoparticles are alumina (i.e., aluminum oxide) nanoparticles.

Alumina nanoparticle aqueous dispersions are available commercially under the trade names VK-L10B (gamma-Al₂O₃, spherical, 10 nm, 20 wt-% dispersion, pH=9) from Hangzhou Wanjing New Materials Co., Ltd., China.

### Coating Methods

Aqueous coating compositions of the present disclosure are preferably coated on a substrate using conventional techniques, such as bar, roll, curtain, rotogravure, spray, or dip coating techniques. The preferred methods include bar and roll coating, or air knife coating to adjust thickness. In order to ensure uniform coating and wetting of the substrate, it may be desirable to oxidize the substrate surface prior to coating using corona discharge or flame treatment methods. Other methods capable of increasing the surface energy of the article include the use of primers such as polyvinylidene chloride (PVDC).

The coatings of the present disclosure are preferably applied in uniform average thicknesses varying by less than 200 Å, and more preferably by less than 100 Å, in order to avoid visible interference color variations in the coating. The optimal average dry coating thickness is dependent upon the particular coating composition, but in general the average thickness of the coating is 500 Å to 2500 Å, preferably 750 Å to 2000 Å, and more preferably 1000 Å to 1500 Å, as measured using an ellipsometer such as a Gaertner Scientific Corp Model No. L115C. Above and below this range, the anti-reflective properties of the coating may be significantly diminished. It should be noted, however, that while the average coating thickness is preferably uniform, the actual coating thickness can vary considerably from one particular point on the coating to another. Such variation in thickness, when correlated over a visibly distinct region, may actually be beneficial by contributing to broad band anti-reflective properties of the coating.

Once coated, the article is preferably dried at a temperature of no greater than 120° C. (although higher temperatures can be used if desired, but they are typically not necessary with the coating compositions of the present disclosure), and more preferably at a temperature of 20° C. to 120° C. This can be carried out in a recirculating oven, for example. If desired, an inert gas may be circulated. The temperature may be increased further to speed the drying process, but care is preferably exercised to avoid damage to the substrate.

### Coated Substrates and Articles

A coating formed from a coating composition of the present disclosure includes agglomerates of inorganic oxide nanoparticles having an average primary particle size of 40 nanometers or less thereon. That is, the inorganic oxide nanoparticles are bonded together through a condensation reaction. The agglomerates include a three-dimensional porous network of inorganic oxide nanoparticles, wherein the inorganic oxide nanoparticles are bonded to adjacent inorganic oxide nanoparticles forming a network of inorganic oxide nanoparticle agglomerates. Preferably, this network is continuous. As used herein, the term “continuous” refers to covering the surface of the substrate with virtually no disdontinuities or gaps in the areas where the gelled network is applied. The term “network” refers to an aggregation or agglomeration of nanoparticles linked together through condensation reactions or by other forms of attraction or bonding to form a porous three-dimensional network. The term “average primary particle size” refers to the average size of unagglomerated single particles of the nanoparticles. Preferably, the particles are spherical and the particle size is a particle diameter.

The term “porous” refers to the presence of voids between the inorganic oxide nanoparticles created when the nanoparticles form a continuous coating. For single layer coatings, it is known that in order to maximize light transmission in air through an optically transparent substrate, and minimize reflection by the substrate, the refractive index of the coating should equal as closely as possible the square root of the refractive index of the substrate and the thickness of the coating should be one-fourth (¼) of the optical wavelength of the incident light. The voids in the coating provide a multiplicity of subwavelength interstices between the nanoparticles where the index of refraction (RI) abruptly changes from that of air (RI=1) to that of the inorganic oxide nanoparticles (e.g., for silica RI=1.44). By adjusting the porosity, a coating having a calculated index of refraction (as shown in U.S. Pat. No. 4,816,333 (Lange, et al.)) that is close to the square root of the refractive index of the substrate, can be created. By utilizing coatings having optimal indices of refraction, at coating thicknesses equal to approximately one-fourth the optical wavelength of the incident light, the percent transmission of light through the coated substrate is maximized and reflection is minimized.

Preferably, the network has a porosity of 25 to 45 volume percent, more preferably 30 to 40 volume percent, when dried. In some embodiments the porosity may be higher. Porosity may be calculated from the refractive index of the coating according to published procedures such as in W. L. Bragg, A. B. Pippard, Acta Crystallographica, vol. 6, page 865 (1953). With silica nanoparticles, this porosity provides a coating having an index of refraction of 1.2 to 1.4, preferably 1.25 to 1.36, which is approximately equal to the square root of the refractive indices of polyester, polycarbonate, or poly(methyl methacrylate) substrates. For example, a porous silica nanoparticle coating having a refractive index of 1.25 to 1.36 is capable of providing a highly anti-reflective surface when coated on a polyethylene terephthalate substrate (RI=1.64) at a thickness of 1000-2000 Å. Coating thicknesses may be higher, as high as a few microns or mils thick, depending on the application, such as for easy-clean or easy removal of undesired particulates, rather than antireflection. The mechanical properties may be expected to be improved when the coating thickness is increased.

Articles of the present disclosure include a substrate which may be of virtually any construction, transparent to opaque, polymeric, glass, ceramic, or metal, having a flat, curved, or complex shape, having high gloss (greater than 90 at an angle of 20) or low gloss (less than 10 at an angle of 20), and having formed thereon a network (preferably, a continuous network) of condensed inorganic oxide nanoparticles.

Exemplary substrates are made of polyester (e.g., polyethylene terephthalate, polybutyleneterephthalate), polycarbonate, allyldiglycolcarbonate, polyacrylates, such as polymethylmethacrylate, polystyrene, polysulfone, polyethersulfone, homo-epoxy polymers, epoxy addition polymers with polydiamines, polydithiols, polyolefins such as polyethylene, polypropylene, polyethylene copolymers and polypropylene copolymers, polyvinyl chloride, fluorinated surfaces, cellulose esters such as acetate and butyrate, glass, ceramic, organic and inorganic composite surfaces, and the like, including blends and laminates thereof.

Typically, the substrate is in the form of a film, sheet, panel or pane of material and may be a part of an article such as ophthalmic lenses, architectural glazings, decorative glass frames, motor vehicle windows and windshields, and protective eye wear, such as surgical masks and face shields. The coatings may, optionally if desired, cover only a portion of the article, e.g., only the section immediately adjacent the eyes in a face shield may be coated. The substrate may be flat, curved, or complex shaped. The article to be coated may be produced by blowing, casting, extrusion, or injection molding.

In some embodiments, the substrate is a flexible film, such as those used in graphics and signage and painted steel panel-like polyurethane or polyester used in automotive and telecommunication, etc. Flexible films may be made from polyesters such as PET, polyolefins such as PP (polypropylene) and PE (polyethylene), or PVC (polyvinyl chloride). The substrate can be formed into a film using conventional filmmaking techniques such as extrusion of the substrate resin into a film and optional uniaxial or biaxial orientation of the extruded film. The substrate can be treated to improve adhesion between the substrate and the coating, using, e.g., chemical treatment, corona treatment such as air or nitrogen corona, plasma, flame, or actinic radiation. If desired, an optional tie layer can also be applied between the substrate and the coating composition to increase the interlayer adhesion. The other side of the substrate may also be treated using the above-described treatments to improve adhesion between the substrate and an adhesive. The substrate may be provided with graphics, such as words or symbols as known in the art.

In certain embodiments, substrates to which the coating compositions of the disclosure can be applied are preferably transparent or translucent to visible light. In other embodiments, the substrate need not be transparent. The term “transparent” means transmitting at least 85% of incident light in a selected portion of the visible spectrum (400-700 nm wavelength). Substrates may be colored or colorless.

When the coating is applied to transparent substrates to achieve increased light transmissivity (i.e., transmission), the coated article preferably exhibits a total average increase (relative to the uncoated substrate) in transmission of normal incident light (preferably, of at least two percent and up to as much as ten percent or more), depending on the substrate coated, over a range of wavelengths extending from 400 to 700 nm. An increase in transmissivity may also be seen at wavelengths into the ultraviolet and/or infrared portion of the spectrum. Certain preferred coating compositions applied to at least one side of a light transmissive substrate increase the percent transmission of the substrate by at least 5 percent, and preferably by 10 percent, when measured at 550 nm. Transparency into the UV region and the near IR region may also increase.

Coatings that result from the compositions of the present disclosure may further provide a water-resistant and mechanically durable hydrophilic surface to a substrate, such as glass and PET substrates, and good antifogging properties under a variety of temperature and high humidity conditions.

Coatings are considered antifogging if a coated substrate resists the formation of small, condensed water droplets in sufficient density to significantly reduce the transparency of the coated substrate such that it cannot be adequately seen through after exposure to repeated human breathing directly on the article and/or after holding the article above a “steam” jet. A coating composition may still be regarded as anti-fogging even though a uniform water film or a small number of large water droplets forms on the coated substrate so long as the transparency of the coated substrate is not significantly reduced such that it cannot be readily seen through. In many instances, a film of water that does not significantly reduce the transparency of the substrate will remain after the substrate has been exposed to a “steam” jet.

Furthermore, the coatings may provide protective layers and exhibit improved cleanability and rinse-away removal of organic contaminates including food and machine oils, paints, dust and dirt, as the nanoporous structure of the coatings tends to prevent penetration by oligomeric and polymeric molecules. By “cleanable” it is meant the coating composition, when cured, provides oil and soil resistance to help prevent the coated article from being soiled by exposure to contaminants such as oils or adventitious dirt. In certain embodiments, a coating from a coating composition of the present disclosure is also easier to clean if it is soiled, so only a simple rinse in water may be all that is required to remove contaminants.

A coating of the present disclosure may also provide antistatic properties to polymeric film and sheet materials subject to static build-up. For example, a preferred coated substrate has a surface resistance of 10¹² Ohms/square or less.

A coating of the present disclosure may also preferably provide abrasion resistance and slip properties to polymeric materials, such as film and sheet materials, thereby improving their handleability.

There are numerous instances where the value of optically clear articles would be enhanced if the tendency of the articles to cause light scattering or glare or to be obscured by the formation of a fog on a surface of the article could be reduced. For example, protective eyewear (goggles, face shields, helmets, etc.), ophthalmic lenses, architectural glazings, decorative glass frames, motor vehicle windows and windshields may all scatter light in a manner that causes an annoying and disruptive glare. Use of such articles may also be detrimentally affected by the formation of a moisture vapor fog on a surface of the article. Ideally, in preferred embodiments, the coated articles of this disclosure have exceptional antifogging properties while also separately having greater than 90 percent transmission of 550 nm light.

The coating may provide a hydrophilic surface or a hydrophobic surface.

As used herein, “hydrophilic” is used only to refer to the surface characteristics of the coating, i.e., that it is wet by aqueous solutions, and does not express whether or not the coating absorbs aqueous solutions. Accordingly, a coating may be referred to as hydrophilic whether or not the coating is impermeable or permeable to aqueous solutions. Surfaces on which drops of water or aqueous solutions exhibit a static water contact angle of less than 50° are referred to as “hydrophilic.” Hydrophobic substrates have a water contact angle of 50° or greater. Coatings described herein may increase the hydrophilicity of a substrate at least 10 degrees, preferably at least 20 degrees.

Preferably, if a hydrophilic coating, the coating of a coated substrate of the present disclosure has a static water contact angle of less than 30°. Preferably, if a hydrophobic coating, the coating of a coated substrate of the present disclosure has a static water contact angle of greater than 90°.

Hydrophobic coatings can be prepared by incorporating, for example, fluorosilanes or long chain alkane silanes into the coating composition. Examples of such compounds include (heptadecafluoro-1,1,2,2-tetrahydrodecyl)triethoxysilane, (heptadecafluoro-1,1,2,2-tetrahydrodecyl)trimethoxysilane, (3-heptafluoroisopropoxy)propyltrimethoxysilane, n-octadecyltrimethoxysilane, and the like. If used, one or more of such compounds is used in an amount of at least 0.001 wt-%, and typically no more than 20 wt-%, based on the dry weight of the inorganic oxide nanoparticles.

In order to uniformly coat a composition onto a hydrophobic substrate from an aqueous system it may be desirable to increase the surface energy of the substrate and/or reduce the surface tension of the coating composition. The surface energy may be increased by oxidizing the substrate surface prior to coating using corona discharge or flame treatment methods. These methods may also improve adhesion of the coating to the substrate. Other methods capable of increasing the surface energy of the article include the use of primers such as thin coatings of polyvinylidene chloride (PVDC). Alternatively, the surface tension of the coating composition may be decreased by addition of lower alcohols (C₁ to C₈).

### Exemplary Embodiments

Embodiment 1 is a coating composition comprising a) inorganic oxide nanoparticles having an average primary particle size of 40 nanometers or less and b) an organic base.

Embodiment 2 is the coating composition of embodiment 1 further comprising water.

Embodiment 3 is the coating composition of embodiment 2 wherein the coating composition is an aqueous dispersion having a pH of greater than 8.

Embodiment 4 is the coating composition of embodiment 3 wherein the aqueous dispersion has a pH of greater than 8.5.

Embodiment 5 is the coating composition of embodiment 4 wherein the aqueous dispersion has a pH of greater than 9.

Embodiment 6 is the coating composition of any one of embodiments 1 through 5 wherein the organic base is selected from the group consisting of an amidine, a guanidine, a phosphazene, a proazaphosphatrane, an alkyl ammonium hydroxide, and a combination thereof.

Embodiment 7 is the coating composition of any one of claims 1 through 6 further comprising a surfactant.

Embodiment 8 is the coating composition of embodiment 7 wherein the surfactant is present in an amount of at least 0.1 wt-%, based on the dry weight of inorganic oxide nanoparticles.

Embodiment 9 is the coating composition of embodiment 7 or embodiment 8 wherein the surfactant comprises a nonionic surfactant, an anionic surfactant, a zwitterionic surfactant, or a combination thereof.

Embodiment 10 is the coating composition of any one of embodiments 1 through 9 wherein the inorganic oxide nanoparticles are present in an amount of at least 0.1 wt-%, based on the total weight of the coating composition.

Embodiment 11 is the coating composition of any one of embodiments 1 through 10 wherein the inorganic oxide nanoparticles have an average primary particle size of 20 nanometers or less.

Embodiment 12 is the coating composition of embodiment 11 wherein the inorganic oxide nanoparticles have an average primary particle size of 10 nanometers or less.

Embodiment 13 is the coating composition of any one of embodiments 1 through 12 wherein the inorganic oxide nanoparticles comprise non-metal oxide nanoparticles.

Embodiment 14 is the coating composition of embodiment 13 wherein the non-metal oxide nanoparticles comprise silica nanoparticles.

Embodiment 15 is the coating composition of any one of embodiments 1 through 12 wherein the inorganic oxide nanoparticles comprise metal oxide nanoparticles.

Embodiment 16 is the coating composition of embodiment 15 wherein the metal oxide nanoparticles comprise alumina nanoparticles.

Embodiment 17 is the coating composition of any one of embodiments 1 through 16 wherein the organic base is present in an amount of at least 0.1 wt-%, based on the total weight of the dry inorganic oxide nanoparticles.

Embodiment 18 is the coating composition of any one of embodiments 1 through 17 comprising:

0.5 to 99 wt-% water, based on the total weight of the composition;

0.1 to 20 wt-% inorganic oxide nanoparticles having an average primary particle size of 40 nm or less, based on the total weight of the composition;

0 to 20 wt-% inorganic oxide nanoparticles having an average primary particle size of 40 nm or more;

wherein the total amount of inorganic oxide nanoparticles is 0.1 to 40 wt-%, based on the total weight of the composition;

0.1 wt-% to 20 wt-% of an organic base, based on the total weight of the dry inorganic oxide nanoparticles; and

0.1 wt-% to 10 wt-% of a surfactant, based on the dry weight of inorganic oxide nanoparticles.

Embodiment 19 is the coating composition of embodiment 18, wherein the pH of the coating composition is greater than 8.

Embodiment 20 is the coating composition of anyone of embodiments 1 to 18 comprising:

0.5 to 99 wt-% water, based on the total weight of the composition;

0.1 to 20 wt-% inorganic oxide nanoparticles having an average primary particle size of 40 nm or less, based on the total weight of the composition;

0.1 wt-% to 20 wt-% of an organic base, based on the total weight of the dry inorganic oxide nanoparticles; and

0 to 10 wt-% of a surfactant, based on the dry weight of inorganic oxide nanoparticles.

Embodiment 21 is the coating composition of embodiment 20, wherein the pH of the coating composition is greater than 8.

Embodiment 22 is the coating composition of embodiment 20 or 21, wherein the coating composition contains 0.1 wt-% to 10 wt-% surfactant, based on the dry weight of inorganic oxide nanoparticles.

Embodiment 23 is a method of coating a substrate, the method comprising: contacting a surface of a substrate with a coating composition and drying the coating composition on the substrate to provide a condensed inorganic oxide nanoparticle coating. The coating composition comprises inorganic oxide nanoparticles having an average primary particle size of 40 nanometers or less; and an organic base.

Embodiment 24 is the method of embodiment 23 wherein the coating composition further comprises water.

Embodiment 25 is the method of embodiment 23 or 24, wherein the method comprises:

contacting a surface of a substrate with an aqueous coating composition comprising: water;

inorganic oxide nanoparticles having an average primary particle size of 40 nanometers or less; and

an organic base;

wherein the coating composition is an aqueous dispersion having a pH of greater than 8; and

wherein a surfactant is present in the aqueous coating composition, disposed on the substrate surface prior to contact with the aqueous coating composition, or both in the aqueous coating composition and disposed on the substrate surface prior to contact with the aqueous coating composition; and

drying the aqueous coating composition on the substrate to provide a condensed inorganic oxide nanoparticle coating.

Embodiment 26 is the method of embodiment 25 wherein the coating composition comprises the surfactant.

Embodiment 27 is the method of embodiment 25 wherein the substrate comprises the surfactant disposed on the surface prior to contact with the aqueous coating composition.

Embodiment 28 is the method of any one of embodiments 23 through 27 wherein the surfactant comprises a nonionic surfactant, an anionic surfactant, a zwitterionic surfactant, or a combination thereof.

Embodiment 29 is the method of any one of embodiments 23 through 28 wherein the organic base is selected from the group consisting of an amidine, a guanidine, a phosphazene, a proazaphosphatrane, an alkyl ammonium hydroxide, and a combination thereof.

Embodiment 30 is the method of any one of embodiments 23 through 29 wherein the inorganic oxide nanoparticles are present in an amount of at least 0.1 wt-%, based on the total weight of the coating composition.

Embodiment 31 is the method of any one of embodiments 23 through 30 wherein the inorganic oxide nanoparticles have an average primary particle size of 20 nanometers or less.

Embodiment 32 is the method of embodiment 31 wherein the inorganic oxide nanoparticles have an average primary particle size of 10 nanometers or less.

Embodiment 33 is the method of any one of embodiments 23 through 32 wherein the inorganic oxide nanoparticles comprise non-metal oxide nanoparticles.

Embodiment 34 is the method of embodiment 33 wherein the non-metal oxide nanoparticles comprise silica nanoparticles.

Embodiment 35 is the method of any one of embodiments 23 through 32 wherein the inorganic oxide nanoparticles comprise metal oxide nanoparticles.

Embodiment 36 is the method of embodiment 35 wherein the metal oxide nanoparticles comprise alumina nanoparticles.

Embodiment 37 is the method of any one of embodiments 23 through 36, as dependent on embodiment 20, wherein the coating composition comprises:

0.5 to 99 wt-% water, based on the total weight of the composition;

0.1 to 20 wt-% inorganic oxide nanoparticles having an average primary particle size of 40 nm or less, based on the total weight of the composition;

0 to 20 wt-% inorganic oxide nanoparticles having an average primary particle size of 40 nm or more;

wherein the total amount of inorganic oxide nanoparticles is 0.1 to 40 wt-%, based on the total weight of the composition;

at least 0.1 wt-% of an organic base, based on the total weight of dry inorganic oxide nanoparticles; and

at least 0.1 wt-% of a surfactant, based on the total amount of dry inorganic oxide nanoparticles.

Embodiment 38 is the method of embodiment 37, wherein the pH of the coating composition is greater than 8.

Embodiment 39 is the method of any one of embodiments 23 through 36, wherein the coating composition comprises:

0.5 to 99 wt-% water, based on the total weight of the composition;

0.1 to 20 wt-% inorganic oxide nanoparticles having an average primary particle size of 40 nm or less, based on the total weight of the composition;

0.1 wt-% to 20 wt-% of an organic base, based on the total weight of the dry inorganic oxide nanoparticles; and

0 to 10 wt-% of a surfactant, based on the dry weight of inorganic oxide nanoparticles.

Embodiment 40 is the method of embodiment 39, wherein the pH of the coating composition is greater than 8.

Embodiment 41 is the method of embodiment 39 or 40, wherein the coating composition contains 0.1 wt-% to 10 wt-% surfactant, based on the dry weight of inorganic oxide nanoparticles.

Embodiment 42 is any one of embodiments 23 through 41, wherein drying to provide a condensed inorganic oxide nanoparticle coating comprises drying the aqueous coating composition on the substrate at a temperature of no greater than 120° C.

Embodiment 43 is the method of embodiment 42 wherein drying to provide a condensed inorganic oxide nanoparticle coating comprises drying the aqueous coating composition on the substrate at a temperature of 20° C. to 120° C.

Embodiment 44 is a coated substrate prepared by the method of any one of embodiments 23 through 43.

Embodiment 45 is the coated substrate of embodiment 44 wherein the coating has a static water contact angle of less than 30°.

Embodiment 46 is the coated substrate of embodiment 44 wherein the coating has a static water contact angle of greater than 90°.

Embodiment 47 is the coated substrate of any one of embodiments 44 through 46 wherein the condensed inorganic oxide nanoparticle coating does not include an organic binder or film former.

Embodiment 48 is the coated substrate of any one of embodiments 44 through 47 wherein the condensed inorganic oxide nanoparticle coating is 500 Å to 2500 Å thick.

Embodiment 49 is the coated substrate of any one of embodiments 44 through 48 wherein the substrate is transparent.

Embodiment 50 is the coated substrate of any one of embodiments 44 through 49 which exhibits an average transmission of normal incident light in the wavelength range of 400 to 700 nm that is higher than that of an uncoated substrate.

Embodiment 51 is the coated substrate of embodiment 50 wherein the average transmission is at least 2 percent higher than that of an uncoated substrate.

Embodiment 52 is the coated substrate of embodiment 51 wherein the inorganic metal oxide comprises alumina.

Embodiment 53 is the coated substrate of embodiment 52 which has a surface resistance of 10¹² Ohms/square or less.

Embodiment 54 is an article comprising a coated substrate of any one of embodiments 44 through 53.

### EXAMPLES

Objects and advantages of this disclosure are further illustrated by the following examples, but the particular materials and amounts thereof recited in these examples, as well as other conditions and details, should not be construed to unduly limit this disclosure. Throughout the examples below “N/M” means that no measurements made.

### Transmittance Measurement

Transmittance data were measured using a Haze-gard Plus Haze Meter (available from BYK-Gardiner, Silver Springs, Md.) according to the procedure described in ASTM D1003. All data are the average of three measurements. The wavelength range for this machine is 400-700 nanometer.

### Contact Angle Measurement

Contact angle measurements were made using deionized water filtered through a filtration system obtained from Millipore Corporation, Billerica, Mass., on a video contact angle analyzer available as product number VCA-2500XE from AST Products, Billerica, Mass.

### Anti-Fogging Property Measurement

The anti-fogging property of the coatings according to the disclosure was determined by breathing over the coatings. Depending on whether and how much fogging was observed on the coatings the anti-fogging property of the coatings were rated to poor, good and excellent. Poor=the appearance of the test sample was milky. Good=the appearance of the test sample was a little hazy. Excellent=the appearance of the test sample was clear.

### Haze Measurement

Haze values disclosed herein were measured using a Haze-Gard Plus Haze Meter (available from BYK-Gardiner, Silver Springs, Md.) according to the procedure described in ASTM D1003. All data are the average of three measurements.

### Ply Adhesion Test (Cross-Hatch Test)

The adhesion of the coatings to the (plastic) substrates was determined by a cross-hatch/tape adhesion test. For this test several scribe marks (3 millimeters apart) were made on the coatings using a razor blade. Then a second set of scribes were made at right angle to the first set. An adhesive film with adhesive side down (“SCOTCH PREMIUM CELLOPHANE TAPE 610”, available from 3M Company, St. Paul, Minn.) was placed over the scribed films and then quickly removed. The film and the adhesive film were examined for damage to the coating. If the percentage of damaged film was 0-10% then, the coating was said to be “good” or “pass” durability otherwise said to be “bad” or “fail” durability.

### Taber Abrasion Test

Mechanical durability of the coatings was determined by subjecting the coated substrates to linear abrasion test either dry or wet (with water). The Taber abrasion test (SDLATLAS CM-5 A.A.T.C.C. Crockmeter, obtained from SDLATLAS, Ontario, Canada) was carried out by wiping the coatings made using the coating compositions describes below with a WYPALL L15 industrial clean paper (obtained from Kimberly Clark Corporation, Dallas, Tex.) as an abrasion media under a constant force of 750 grams/cm² (7.35 N/cm²). The abrasion test was run and the water contact angle of the abraded coatings was tested after 20, 50, 100 and 200 cycles. The test was stopped, and number of cycles of the previous reading recorded, when the water contact angle of the abraded coating reached to above 30° for the hydrophilic coatings.

### Anti-Dust Test

For this test the coated samples were mounted on a hard substrate such as a glass plate and then 900 grams of soil containing glass beads and soil at 500:1 ratio were placed over the coated sample. The assembly was then placed over a shaker (model IKA-KS-4000IC obtained from IKAWerke GmbH & Co. KG, Staufen, Germany) in an enclosure and shaken at 250 rpm for 1 minute. After shaking was completed, the samples were taken out of the enclosure and loose dust was removed by tapping gently. Average haze and transmission were then measured according to methods described herein. The lower the haze and the higher the transmission, the better were the anti-dust properties.

### Anti-Static Test (Surface Resistance Measurement)

Surface resistance measurement of coatings was done by ACL Staticide Model 385 Resistivity Meter, Precision International Corporation, Taibei, Taiwan. The higher surface resistance, the poorer are the anti-static properties.

### pH Measurement

The pH of coating formulation was obtained by measuring these dispersions with a pH meter (Model 340, Corning Incorporated Corning, N.Y. 14831, USA).

### Materials

The following list of materials and their sources are referred to throughout the Examples.

| Material | Description |
|---|---|
| NALCO 1034A | An aqueous (spherical, 20 nm, 34 wt.-%) colloidal silica |
| | dispersion obtained from Nalco Co., Naperville, IL under |
| | trade designation “NALCO 1034A” |
| NALCO 1115 | An aqueous (spherical, 4 nm, 15 wt-%) colloidal silica |
| | dispersion obtained from Nalco Co., Naperville, IL under |
| | trade designation “NALCO 1115” |
| NALCO 2326 | An aqueous (spherical, 5 nm, 15 wt-%) colloidal silica |
| | dispersion obtained from Nalco Co., Naperville, IL under |
| | trade designation “NALCO 2326” |
| NALCO 8699 | An aqueous (spherical, 2 nm, 15 wt-%, colloidal silica |
| | dispersion obtained from Nalco Co., Naperville, IL under |
| | trade designation “NALCO 8699” |
| ST-OUP | An aqueous (elongated, 40-100 nm, 15 wt-%) colloidal silica |
| | dispersion obtained from Nissan Chemical Industries, Japan |
| Sodium dodecylbenzenesulphonate | Obtained from Shanghai Guoyao Group, China |
| 1,8-diazabicyclo(5.4.0)undec-7-ene | (DBU), obtained from Shanghai Rongrong Chemical Ltd., |
| | China |
| 1,5-Diazabicyclo[4.3.0]-5-nonene | (DDM), obtained from Aldrich Chemical Company, |
| | Milwaukee, WI |
| Tetramethyl Ammonium Hydroxide | ((CH₃)₄NOH, 25 wt-% water solution) was obtained from |
| | Shanghai Hanhong Chemical Ltd., China |
| 1,5,7-triazabicyclo[4,4,0]dec-5-ene | (TBD), obtained from Aldrich Chemical Company, |
| | Milwaukee, WI |
| (2,8,9-triisopropyl-2,5,8,9-tetraaza-1- | (TTPU), Obtained from Aldrich Chemical Company, |
| phosphabicyclo[3,3,3]undecane) | Milwaukee, WI |
| P1-t-Bu(Phosphazene base P1-t-Bu- | (P₁-t-Bu), obtained from Aldrich Chemical Company, |
| tris(tetramethylene)) | Milwaukee, WI |
| NALCO 8676 | An aqueous (spherical, 2 nm, 10 wt-%, pH = 5) alumina |
| | nanoparticle dispersion obtained from Nalco Co., Naperville, |
| | IL under trade designation “NALCO 8676” |
| VK-L10B | An aqueous (spherical, 10 nm, 20 wt-%, pH = 9) gamma |
| | alumina nanoparticle dispersion obtained from Hongzhou |
| | Wanjing New Materials Co., China, under trade designation |
| | “VK-L10B” |
| SURFYNOL 465 | Surfactant, obtained from Air Products and Chemicals (China) |
| | Investment Co., Ltd., China, under trade designation |
| | “SURFYNOL 465” |
| SURFYNOL 485 | Surfactant, obtained from Air Products and Chemicals (China) |
| | Investment Co., Ltd., China under trade designation |
| | “SURFYNOL 485” |
| SURFYNOL 504 | Surfactant, obtained from Air Products and Chemicals (China) |
| | Investment Co., Ltd., China under trade designation |
| | “SURFYNOL 504” |
| Polycarbonate (PC) Film | Obtained from Mitsubishi Engineering Plastics Corporation, |
| | Greer, SC under trade designation HOSTAPHAN 3SAB) |
| PET Film | 50-75 micron thick, was obtained from E.I. Du Pont de |
| | Nemours, Wilmington DE under trade designation “DU |
| | PONT 618 PET FILM” |
| PVDC-Primed PET Film | PVDC-PET transparent polyester film, available under the |
| | trade designation “SCOTCHPAK 9962” from 3M Company, |
| | St. Paul, MN |
| Polypropylene Film | 55 micrometer thick, obtained from Guangdong Profol Films, |
| | Guangdong, China |
| IPA-ST-MS | An non-aqueous (spherical, approximately 20 nm, 30 wt-%, |
| | pH = 2-4) silica sol obtained from Nissan Chemical America |
| | Corporation, Houston, TX, under trade designation “IPA-ST- |
| | MS” |
| BERESOL EC | Surfactant, obtained from Akzo Nobel, Amsterdam, |
| | Netherlands under trade designation “BERESOL EC” |
| BYK-346 | Silicone surfactant, obtained from BYK-Gardner USA, |
| | Columbia, MD under trade designation “BYK-346” |
| H₃PO₄ | Obtained from Guoyao Group, Shanghai, China |
| NaOH | Obtained from Guoyao Group, Shanghai, China |

### Coating Solution S1

The S1 was prepared by diluting NALCO 2326 (3.33 grams) with deionized (DI) water (6.67 grams) in a 20 mL glass jar to form a 5 wt-% aqueous silica dispersion. To this dispersion was added DBU (0.025 grams), followed by the addition of, a 5 wt-% aqueous solution of sodium dodecylbenzenesulphonate solution (0.12 grams). The S1 coating solution was a 5 wt-% aqueous silica dispersion with a pH of 9.5.

### Coating Solutions S2-S8 and Control Solutions CS1-CS3

The S2-S8 coating solutions and CS1-CS3 control solutions were prepared in the same manner as S1, except that the type and wt-% of the bases were varied as described in Table 1 below. All samples were made at 5 wt-% silica dispersions and with sodium dodecylbenzenesulphonate at 1.2 wt-% of the silica solids in the final coating solutions.

TABLE 1

| | | | Organic Base | pH of |
|---|---|---|---|---|
| Coating | Silica | | Concentration | Coating |
| Solution | Dispersion | Organic Base | (wt-% of Silica) | Solution |
| S1 | NALCO 2326 | DBU | 5 | 9.5 |
| S2 | NALCO 2326 | (CH₃)₄NOH | 5 | 9.6 |
| S3 | NALCO 2326 | DBN | 5 | 9.5 |
| S4 | NALCO 2326 | TBD | 5 | 9.6 |
| S5 | NALCO 2326 | TTPU | 5 | 9.4 |
| S6 | NALCO 2326 | P1-t-Bu | 5 | 9.4 |
| S7 | NALCO 2326 | DBU | 1 | 9.2 |
| S8 | NALCO 2326 | (CH₃)₄NOH | 3 | 9.5 |
| CS1 | NALCO 2326 | NaOH | 5 | 10.5 |
| CS2 | NALCO 2326 | No organic base | 5 | 1.7 |
| | | used, H₃PO₄ acid | (acid, not base) | |
| | | used as | | |
| | | comparative | | |
| CS3 | NALCO 2326 | None | 0 | 9.0 |

### Mixed Silica Coating Solution S9

The S9 coating solution was prepared by mixing ST-OUP (9.00 grams of a 2.8 wt-% aqueous dispersion) and NALCO 1115 (1.00 gram of a 2.8 wt-% aqueous dispersion) in a 20 mL glass jar. To this mixture was further added DBU (0.014 grams) and a 5 wt-% aqueous solution of sodium dodecylbenzenesulphonate solution (0.12 grams). The S9 coating solution had a pH of 8.9.

### Coating Solutions S10-S12 and Control Solution CS4

The S10-S12 coating solutions were prepared in the same manner as S9 above, except that the wt-% of the silica dispersion and type of bases were varied as described in Table 2 below. Note that “N/M” means “Not Measured”.

The amount of sodium dodecylbenzenesulphonate was maintained constant at 2.1 wt-% of the silica solids in the final coating solutions. The amount of base was maintained at 5 wt-% of the silica solids in the final coating solutions.

The CS4 control solution was prepared in the same manner as S9 above, except that H₃PO₄ was used that was sufficient to adjust the coating solution pH to 2.3.

TABLE 2

| | | | SiO₂ | pH of |
|---|---|---|---|---|
| Coating | | | Concentration | Coating |
| Solution | Silica Dispersion | Organic Base | (wt-%) | Solution |
| S9 | ST-OUP + NALCO | DBU | 2.8 | 8.9 |
| | 1115 (9:1, wt:wt) | | | |
| S10 | ST-OUP + NALCO | (CH₃)₄NOH | 10 | 9.9 |
| | 1115 (9:1, wt:wt) | | | |
| S11 | ST-OUP + NALCO | DBN | 10 | N/M |
| | 1115 (9:1, wt:wt) | | | |
| S12 | ST-OUP + NALCO | DBN | 5 | 10.1 |
| | 1115 (9:1, wt:wt) | | | |
| CS4 | ST-OUP + NALCO | No organic | N/M | 2.3 |
| | 1115 (9:1, wt:wt) | base used, | | |
| | | H₃PO₄ acid | | |
| | | used as | | |
| | | comparative | | |

### Coating Solution S13

The S13 coating solution was prepared by first diluting NALCO 1034A (1.47 grams) with deionized (DI) water (8.53 grams) in a 20 mL glass jar to form a 5 wt-% dispersion, followed by the addition of DBU (0.50 gram of a 5 wt-% aqueous solution) and sodium dodecylbenzenesulphonate (0.20 gram of a 5 wt-% aqueous solution). The final formulation was a clear solution with a pH of 11.1.

### Coating Solutions S14-S16 and Control Solution CS5

The S14-S16 coating solutions and CS5 control solution were prepared in the same manner as S13, except that the amount of the DBU (a 5 wt-% aqueous solution) added was 0.30 gram 0.10 gram, 0.20 grain and 0 gram, respectively. The amount of the surfactant sodium dodecylbenzenesulphonate was maintained constant at 2% of the dry silica weight. The pH of the resulting solutions was 10.3, 8.9, 9.7, and 6.8, respectively.

### Coating Solution S17

The S17 coating solution was prepared by diluting NALCO 8699 (2.00 grams) with deionized (DI) water (6.67 grams) in a 20 mL glass jar to form a 3.5 wt-% aqueous silica dispersion. To this dispersion was added DBU (0.015 grams), followed by the addition of a 5 wt-% aqueous solution of BERESOL EC (1.00 grams) and of BYK-346 (0.020 grams).

### Coating Solution (S1F)

A silica IPA solution (IPA-ST-MS from Nissan Chemicals, 30% solids, 10.0 g) was diluted with IPA (50.0 g) to prepare a 5% silica solution in IPA. To 10 g of this solution was added N-methyl-N-(trimethoxysilylpropyl)perfluorooctylsulfamide (0.100 g), followed by addition of DBU (0.025 g). This formulation was a clear solution.

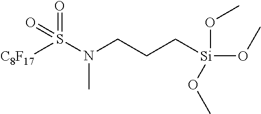

### Example 1

Example 1 was prepared by coating Solution S1 prepared above onto a corona-treated polycarbonate film ((Corona PC), Model DY-2 corona treater, Shanghai Haocui Electronics Technology Co., Ltd., Shanghai, China) with a Number 3 (#3) Meyer bar. The film was treated by manually feeding it through the treater at a speed of 2 meters/minute rate at a power setting of 1.5 kW. The thickness (theoretical wet thickness) was 7.7 micrometers. This coating was cured for 5 minutes in an oven at 120° C. into a clear film.

### Examples 2-21 and Comparative Examples A-K

Examples 2-21 and Comparative Examples A-K samples were prepared in the same manner as Example 1 above except that the coating substrates, wet coating thickness, and the curing conditions were varied as described in Table 3 below. Comparative Samples J and K are bare substrate films without coatings.

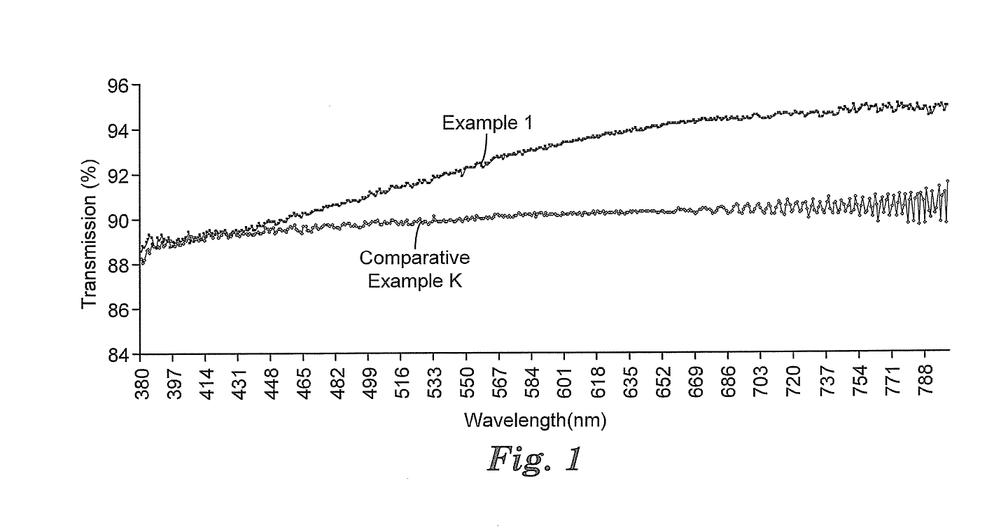

FIG. 1 is a comparison of Percent Transmittance between Comparative Example K and Example 1 over the wavelength range of 380-800 nanometers. The data was obtained using All data are the average of three measurements. Transmittance spectra were obtained using a Lamda 900 UV/VIS/NIR

Spectrometer, obtained from PerkinElmer, Massachusetts, USA Table 3 summarizes the Taber Abrasion and Ply adhesion data. Note that“N/M” means “Not Measured”.

Table 4 below summarizes the average transmission (average T) and average haze for Example 21 and Comparative Examples I and J before and after 40 cycles of Taber Abrasion-dry testing.

TABLE 3

| | | | Wet Coating | | | | |
|---|---|---|---|---|---|---|---|
| | Coating | | Thickness, | | Taber Abrasion- | Taber Abrasion- | |
| Example | Solution | Substrate | (micrometer) | Curing Conditions | dry (cycles) | wet(cycles) | Ply Adhesion |
| 1 | S1 | Corona-PC | 7.7 | 120° C./5 min | 200 | 50 | pass |
| 2 | S1 | PC(as is) | 6.0 | 120° C./5 min | greater than20 | N/M | N/M |
| 3 | S1 | PVDC-PET | 7.7 | 120° C./5 min | 200 | 200 | pass |
| 4 | S1 | Corona-PC | 6.0 | 80° C./30 min | 20 | 20 | N/M |
| 5 | S2 | Corona-PC | 6.0 | 120° C./5 min | 200 | 20 | Pass |
| 6 | S3 | Corona-PC | 6.0 | 120° C./5 min | 50 | 50 | Pass |
| 7 | S4 | Corona-PC | 7.7 | 120° C./5 min | 200 | 100 | Pass |
| 8 | S5 | Corona-PC | 7.7 | 120° C./5 min | 100 | 20 | Pass |
| 9 | S6 | Corona-PC | 7.7 | 120° C./5 min | 200 | 20 | Pass |
| Comp. A | CS1 | Corona-PC | 6.0 | 120° C./5 min | 200 | 200 | Pass |
| Comp. B | CS2 | Corona-PC | 6.0 | 120° C./5 min | less than20 | less than20 | N/M |
| Comp. C | CS3 | Corona-PC | 6.0 | 120° C./5 min | less than20 | less than20 | N/M |
| Comp. D | CS1 | Corona-PC | 6.0 | 50° C./30 min | 50 | less than20 | N/M |
| Comp. E | CS2 | Corona-PC | 6.0 | 50° C./30 min | less than20 | less than20 | N/M |
| Comp. F | CS3 | Corona-PC | 6.0 | 50° C./30 min | less than20 | less than20 | N/M |
| 10 | S7 | Corona-PC | 6.0 | 50° C./30 min | 100 | less than20 | N/M |
| 11 | S7 | Corona-PC | 6.0 | 120° C./5 min | 100 | 100 | N/M |
| 12 | S8 | Corona-PC | 6.0 | 50° C./30 min | 20 | less than20 | N/M |
| 13 | S9 | Flash-PET | 6.0 | 120° C./5 min | 200 | 100 | N/M |
| 14 | S10 | Corona-PC | 6.0 | 50° C./30 min | less than20 | less than20 | N/M |
| 15 | S11 | PC(as is) | 6.0 | 120° C./5 min | 200 | 50 | N/M |
| 16 | S12 | PC(as is) | 6.0 | 120° C./5 min | 20 | 50 | N/M |
| Comp. G | CS4 | PC(as is) | 6.0 | 120° C./5 min | less than20 | less than20 | N/M |
| 17 | S13 | PVDC-PET | 6.0 | 120° C./5 min | less than20 | 80 | N/M |
| 18 | S14 | PVDC-PET | 6.0 | 120° C./5 min | less than20 | 80 | N/M |
| 19 | S15 | PVDC-PET | 6.0 | 120° C./5 min | less than20 | 80 | N/M |
| 20 | S16 | PVDC-PET | 6.0 | 120° C./5 min | 20 | 40 | N/M |
| Comp. H | CS5 | PVDC-PET | 6.0 | 120° C./5 min | less than20 | 20 | N/M |
| 21 | S1 | PVDC-PET | 12 | 120° C./5 min | N/M | N/M | N/M |
| Comp. I | CS3 | PVDC-PET | 12 | 120° C./5 min | N/M | N/M | N/M |
| Comp. J | None | PVDC-PET | None | N/M | N/M | N/M | N/M |
| Comp. K | None | PC (as is) | None | N/M | N/M | N/M | N/M |

TABLE 4

| | | | Wet Coating | As Prepared | | After Taber Abrasion-Dry (40 cycles) | |
|---|---|---|---|---|---|---|---|
| | Coating | | Thickness, | Average | Average | Average | |
| Example | Solution | Substrate | (micrometer) | T(%) | Haze | T(%) | Average Haze |
| 21 | S1 | PVDC- | 12 | 94.6 | 0.8 | 94.1 | 1.6 |
| | | PET | | | | | |
| Comp. I | CS3 | PVDC- | 12 | 94.3 | 2.0 | 92.0 | 10.2 |
| | | PET | | | | | |
| Comp. J | No | PVDC- | 0 | 91.6 | 1.2 | 91.6 | 4.0 |
| | coating | PET | | | | | |

### Example 22 and Comparative Example L

Example 22 was prepared in the same manner as Example 1 except that the Coating Solution S1F was coated on glass substrates. The coatings had a wet thickness of 7.7 micrometers and were cured at 120° C. for 5 min. Comparative Example L was the bare glass substrate. The water contact angles of Example 22 and Comparative Example L were measured to be 115.0 and 49.5 degrees, respectively.

### Coating Solutions 18, 19 and Control Solutions CS6-CS7 (S18, S19, CS6 and CS7)

The S18 was prepared by first diluting 2.5 grams of VK-L10B alumina sol with 7.5 grams of deionized (DI) water in a 20 mL glass jar to form a 5 wt-% alumina sol. To the diluted alumina sol, 0.50 gram of a 5% aqueous DBU solution was added. The amount of DBU present in the final coating solution was 5 wt-% of alumina solids. The pH of the resulting solution was 10.5.

The S19 was prepared by adding sodium dodecylbenzenesulphonate (1.2 wt-% of the alumina solids) to the coating solution S18. CS6-CS7 were prepared in the same manner as S18 except that the base were varied. CS6 did not have any base. CS7 had H₃PO₄ acid in an amount such that the final coating solution had a pH of 2.0.

### Example 23-27 and Comparative Examples M-P

Example 23 was prepared by coating the Solution S18 prepared above onto a PVDC-primed PET (PVDC-PET) by using a Number 1 (#1) Meyer rod. The thickness (theoretical wet thickness) was 6.0 micrometer. The resulting coating was cured at for 5 minutes in a 120° C. oven.

Examples 24-27 and Comparative Examples M-P were prepared in the same manner as Example 23 above except that the coating solutions, coating thicknesses, substrates and the curing conditions were varied as described in Table 5 below. The Tables below also summarize properties of corresponding Examples and Comparative Examples J and M-P.

TABLE 5

| | | | Wet Coating | | Taber | Taber | | Surface | | |
|---|---|---|---|---|---|---|---|---|---|---|
| | Coating | | Thickness, | Curing | Abrasion-dry | Abrasion-wet | Ply | Resistivity | Average | |
| Example | Solution | Substrate | (micrometer) | Conditions | (100cycles) | (100cycles) | Adhesion | (Ohms/sq) | T (%) | Haze |
| 23 | S18 | PVDC-PET | 6.0 | 120° C./5 min | Pass | Pass | Good | 10¹¹⁻¹² | 91.5 | 0.32 |
| 24 | S18 | PVDC-PET | 12.0 | 120° C./5 min | N/M | N/M | N/M | 10¹¹⁻¹² | 91.4 | 2.03 |
| 25 | S18 | PVDC-PET | 24.0 | 120° C./5 min | N/M | N/M | N/M | 10¹¹⁻¹² | 92.5 | 8.35 |
| 26 | S19 | Corona PP | 12 | 90° C./2 min | N/M | N/M | N/M | 10¹² | N/M | N/M |
| 27 | S19 | Corona PC | | 120° C./5 min | N/M | N/M | N/M | N/M | N/M | N/M |
| Comp. M | CS6 | PVDC-PET | 6.0 | 120° C./5 min | Fail | Pass | Good | N/M | N/M | N/M |
| Comp. N | CS7 | PVDC-PET | 6.0 | 120° C./5 min | Fail | Pass | Good | N/M | N/M | N/M |
| Comp. O | CS6 | Corona PP | 12.0 | 90° C./2 min | N/M | N/M | N/M | 10¹¹⁻¹² | N/M | N/M |
| Comp. P | None | Corona PC | N/M | N/M | N/M | N/M | N/M | N/M | N/M | N/M |
| Comp. J | None | PVDC-PET | None | None | N/M | N/M | N/M | greater than10¹² | 90.9 | 0.25 |

All samples in Table 5 are hydrophilic coatings with initial water contact angle of less than (less than) 10°. For Taber Abrasion data in Table 5, “Pass” t means water contact angles at the end of 100-cycle abrasion were still less than 30°. Otherwise, it was rated as “Fail.” “N/M” means “Not Measured”. Table 6 below summarizes the percent average transmission (average T(%)) and Haze before and after anti-dust testing as well as anti-fogging performance of Examples 1, 27, and Comparative Example P.

TABLE 6

| | | Haze | | Average T (%) | |
|---|---|---|---|---|---|
| | Anti-Fog | As | After anti- | As | After anti- |
| Example | Test | Prepared | dust test | Prepared | dust test |
| 1 | Excellent | 0.4 | 8.9 | 95.0 | 93.0 |
| 27 | Excellent | 0.3 | 10.2 | 95.0 | 93.0 |
| Comp. P | Poor | 0.4 | 25.5 | 92.2 | 86.6 |

### Example 28

Two steel panels, one coated with a polyester, and the other coated with a polyurethane (obtained from Shanghai Yutai Communications Electronics Co., Ltd., Shanghai, China) were coated with solution S17 (curtain coating). The wet coatings were gently wiped with sponges to make the coatings uniform. The coatings were dried at room temperature for 48 hours. The estimated average dry coating thickness was 400 nm. The coated panels were left outdoors in a dusty environment for 30 days. The panels were visually inspected for anti-dust performance and they were found much cleaner than the control samples without coatings.

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1-8. (canceled)

9. A method of coating a substrate, the method comprising:
contacting a surface of a substrate with a coating composition comprising:
inorganic oxide nanoparticles having an average primary particle size of 40 nanometers or less; and
an organic base; and
drying the coating composition on the substrate to provide a condensed inorganic oxide nanoparticle coating.

10. The method of claim 9 wherein the method comprises:
contacting a surface of a substrate with an aqueous coating composition comprising:
water;
inorganic oxide nanoparticles having an average primary particle size of 40 nanometers or less; and
an organic base;
wherein the coating composition is an aqueous dispersion having a pH of greater than 8; and
wherein a surfactant is present in the aqueous coating composition, disposed on the substrate surface prior to contact with the aqueous coating composition, or both in the aqueous coating composition and disposed on the substrate surface prior to contact with the aqueous coating composition; and
drying the aqueous coating composition on the substrate to provide a condensed inorganic oxide nanoparticle coating.

11. The method of claim 9 wherein the coating composition further comprises a surfactant.

12. A coated substrate prepared by the method of claim 9.

13. The coated substrate of claim 12 wherein the coating has a static water contact angle of less than 30° or greater than 90°.

14. The coated substrate of claim 12 wherein the condensed inorganic oxide nanoparticle coating does not include an organic binder or film former.

15. An article comprising a coated substrate of claim 14.

16. The method of claim 9 wherein the organic base is selected from the group consisting of an amidine, a guanidine, a phosphazene, a proazaphosphatrane, an alkyl ammonium hydroxide, and a combination thereof.

17. The method of claim 9 wherein the inorganic oxide nanoparticles have an average primary particle size of 20 nanometers or less.

18. The method of claim 9 wherein the non-metal oxide nanoparticles comprise silica nanoparticles.

19. The method of claim 9 wherein the metal oxide nanoparticles comprise alumina nanoparticles.

20. The method of claim 9 wherein the coating composition comprises:
0.5 to 99 wt-% water, based on the total weight of the composition;
0.1 to 20 wt-% inorganic oxide nanoparticles having an average primary particle size of 40 nm or less, based on the total weight of the composition;
0 to 20 wt-% inorganic oxide nanoparticles having an average primary particle size of 40 nm or more;
wherein the total amount of inorganic oxide nanoparticles is 0.1 to 40 wt-%, based on the total weight of the composition;
at least 0.1 wt-% of an organic base, based on the total weight of dry inorganic oxide nanoparticles; and
at least 0.1 wt-% of a surfactant, based on the total amount of dry inorganic oxide nanoparticles.

21. The method of claim 20 wherein the pH of the coating composition is greater than 8.

22. The method of claim 9 wherein drying to provide a condensed inorganic oxide nanoparticle coating comprises drying the aqueous coating composition on the substrate at a temperature of no greater than 120° C.

23. The coated substrate of claim 12 wherein the condensed inorganic oxide nanoparticle coating is 500 Å to 2500 Å thick.

24. The coated substrate of claim 12 wherein the substrate is transparent.

25. The coated substrate of claim 12 which exhibits an average transmission of normal incident light in the wavelength range of 400 to 700 nm that is higher than that of an uncoated substrate.

26. The coated substrate of claim 25 wherein the average transmission is at least 2 percent higher than that of an uncoated substrate.

27. The coated substrate of claim 26 wherein the inorganic metal oxide comprises alumina.

28. The coated substrate of claim 27 which has a surface resistance of 10¹² Ohms/square or less.
